(19) United States
(12) Patent Application Publication
(10) Pub. No.: US 2026/0327131 A1
(43) Pub. Date: Oct. 22, 2026

(54) Copper Molybdenum Tailings Based Alkali Activated Cementitious Material and Preparation Method

(71) Applicant: Northeastern University, Shenyang (CN)

(72) Inventors: Xiaowei GU, Shenyang (CN); Fengdan WANG, Shenyang (CN); Xiaowei GE, Shenyang (CN); Xiaochuan XU, Shenyang (CN); Xu WANG, Shenyang (CN); Shenyu WANG, Shenyang (CN); Ziyang HU, Shenyang (CN); Zhihang HU, Shenyang (CN); Bohan YANG, Shenyang (CN); Jianping LIU, Shenyang (CN); Qing WANG, Shenyang (CN); Hao WANG, Shenyang (CN)

(21) Appl. No.: 19/693,372

(22) Filed: May 30, 2026

(30) Foreign Application Priority Data
Dec. 4, 2025 (CN) 202511813850.8

(51) Int. Cl. C04B 18/04; C04B 14/10; C04B 18/06; C04B 18/08; C04B 18/14; C04B 22/00; C04B 22/06; C04B 24/26; C04B 103/00; C04B 103/10

(52) U.S. Cl. CPC C04B 18/0472; C04B 14/106; C04B 18/0427; C04B 18/067; C04B 18/08; C04B 18/142; C04B 22/002; C04B 22/062; C04B 24/26; C04B 2103/0006; C04B 2103/10

(57) ABSTRACT

The present disclosure belongs to the field of solid waste resource utilization and building materials technology, specifically relates to a copper molybdenum tailings based alkali activated cementitious material and preparation method. The copper molybdenum tailings based alkali activated cementitious material including: solid waste dry mixture, alkali activator solution, silicone acrylic lotion and modified nano-silica; where the solid waste dry mixture is composed of 50-70 parts of copper molybdenum tailings; 10-30 parts of auxiliary calcium material; 10-20 parts of silicon aluminum correction material. The method of the present disclosure can achieve a large-scale consumption of copper molybdenum tailings and prepare cementitious materials with excellent mechanical properties and good stability.

### TECHNICAL FIELD

The present disclosure belongs to the field of solid waste resource utilization and building materials technology, and specifically relates to a copper molybdenum tailings based alkali activated cementitious material and preparation method.

### BACKGROUND

Copper molybdenum ore has a complex composition and severe co-occurrence. Tailings produced by flotation extraction of copper concentrates and molybdenum concentrates are called copper molybdenum tailings. A current main method of handling is storage. Not only occupy land, but also exist ecological pollution hazards and geological disaster risks, seriously threatening safety of people's lives and property in mining areas. How to utilize copper molybdenum tailings on a large scale and with high added value is an urgent problem that needs to be solved in the fields of mining and environmental protection.

Alkali activated cementitious material is a new type of green building material that mainly uses solid waste rich in silicon and aluminum (such as slag, fly ash, etc.) as raw materials. Through an action of strong alkali activators, the alkali activated cementitious material depolymerized and re-polymerized to form a three-dimensional network structure with cementitious properties. Compared with traditional Portland cement, the alkali activated cementitious material has advantages of low energy consumption, low carbon dioxide emissions, excellent mechanical properties, and good corrosion resistance. At present, research on alkali activated cementitious material is mainly focused on fly ash, blast furnace slag, and other materials. The content and activity of SiO₂ and Al₂O₃ in copper molybdenum tailings are significantly different from those in fly ash and slag, and may contain specific impurities. Directly applying existing formulas often results in poor activation effects, leading to low material strength and poor stability.

Chinese patent CN111454011B provides a method and alkali activated cementitious material for preparing alkali activated cementitious materials using engineering slag. The alkali activated cementitious material is prepared using engineering slag as raw material, without a need for sediment separation treatment or cement addition, and can fully reuse engineering slag.

The existing cementitious material facing problems of insufficient strength and poor durability in practical applications, especially in cold regions where frost resistance and freeze-thaw cycle performance are poor, seriously restricting the service life of engineering structures.

Therefore, it is necessary to develop a formula and preparation process for alkali activated cementitious materials specifically targeting mineralization characteristics of copper molybdenum tailings.

### SUMMARY

The purpose of the present disclosure is to provide copper molybdenum tailings based alkali activated cementitious material and preparation method.

In order to achieve the above objectives, the present disclosure provides the present technical solution:

A copper molybdenum tailings based alkali activated cementitious material, including: solid waste dry mixture, alkali activator solution, silicone acrylic lotion and modified nano-silica; where the solid waste dry mixture is composed of 50-70 parts of copper molybdenum tailings; 10-30 parts of auxiliary calcium material; 10-20 parts of silicon aluminum correction material.

The alkali activator solution includes sodium silicate solution, sodium hydroxide solution, and water. A modulus of sodium silicate (SiO₂/Na₂O) in the alkaline activator solution is 1.2-2.0. In the alkaline activator solution, Na₂O equivalent is calculated, and a mass of Na₂O is 4%-10% of a mass of solid waste dry mixture; a ratio of a mass of water in the alkali activator solution to a mass of solid waste dry mixture is 0.40-0.60.

In some embodiments, the auxiliary calcium material is one of granulated blast furnace slag powder, steel slag, and carbide slag or more of granulated blast furnace slag powder, steel slag, and carbide slag. The function is providing necessary Ca²⁺, promoting a formation of C-(A)-S—H gel, interweaving with N-A-S—H gel generated by tailings excitation, and optimizing a microstructure.

In some embodiments, the silicon aluminum correction material is one of low calcium fly ash and high kaolin or more of low calcium fly ash and high kaolin. Where the function is adjusting a Si/Al ratio and Al/Na ratio of the system, improving degree of reaction and long-term stability of the silicon aluminum correction material.

In some embodiments, the silicone acrylic lotion includes silicone acrylic lotion A and silicone acrylic lotion B with a mass ratio of 1.5-1.8:1.

The silicone acrylic lotion A has a viscosity of 500-1500 mPa·s, a glass transition temperature of 15-25 °C, a freeze-thaw stability is achieved through 5 cycles. The silicone acrylic lotion A is produced by Jiangsu Shengda New Material Technology Co., Ltd., a model is SD-528 Silicone Acrylic Lotion.

The silicone acrylic lotion B has a viscosity of 500-1500 mPa·s, a glass transition temperature of 13-28 °C, and particle size of 50-80 nm, a freeze-thaw stability is achieved through 5 cycles. The silicone acrylic lotion B is produced by Jiangsu Shengda New Material Technology Co., Ltd., a model is SD-5281 nano-silicone acrylic lotion.

The cementitious material strength can be improved by using a specific type of silicone acrylic lotion in the cementitious material of the present disclosure. It is analyzed that the silicone acrylic lotion under the condition in the present disclosure can better achieve synergy with the modified nano-silica. A polymer film fills and seals pores and microcracks, making pore structure of the cementitious material more refined, macropores reduced and micropores increased. The denser microstructure greatly improves strength and durability, and at the same time greatly strengthens interface transition zone, making the interface transition zone changes from a weakest link of the cementitious material to a reinforcement link.

In some embodiments, silicone acrylic lotion accounts for 6-8% of the mass of the solid waste dry mixture.

In some embodiments, a preparation method of modified nano-silica including:
s1: adding polyetheramine to anhydrous xylene, dispersing evenly to obtain dispersion liquid;
s2: adding triethylamine and γ-glycidoxypropyltrimethoxysilane to the dispersion liquid, heating and reacting to obtain a mixed system;
s3: adding nano-silica to anhydrous xylene, dispersing evenly, and obtain a nano-silica suspension;
under nitrogen protection; after the reflux reaction is complete, filtering and drying to obtain modified nano-silica.

In some embodiments, an amine active hydrogen equivalent in polyetheramine is 130-135 g/eq.

In some embodiments, a molar ratio of amine group in the polyetheramine to the γ-glycidoxypropyltrimethoxysilane is (2-2.2):1.

Direct adding nano-silica to cementitious material in existing technology does not have a significant effect on improving performance. The present disclosure modifies nano-silica to improve freeze-thaw resistance of the cementitious material. Analysis shows long polymer chains generated steric hindrance effect, preventing the nano-silca aggregating in slurry and enabling the nano-silca to be more evenly dispersed, thereby filling a wider range of pores more efficiently.

In some embodiments, the modified nano-silica accounts for 0.8-1.2% of the mass of the solid waste dry mixture.

A preparation method of copper molybdenum tailings based alkali activated cementitious material, including:
s1: raw material pretreatment: drying and grinding copper molybdenum tailings to obtain pretreated copper molybdenum tailings;
s2: material mixing: mixing the pretreated copper molybdenum tailings, auxiliary calcium material, and silicon aluminum correction material evenly to obtain a solid waste dry mixture;
s3: mixing molding: mixing the solid waste dry mixture, alkali activator solution, silicone acrylic lotion and modified nano-silica, using cement paste mixer for 4-6 min to obtain uniform slurry;
s5: maintaining: maintaining at room temperature of 20-25 °C after forming the uniform slurry to obtain copper molybdenum tailings based alkali activated cementitious material.

Compared with the existing technology, advantages and beneficial effects of the present disclosure are:

1. The present disclosure first uses copper molybdenum tailings as main raw material for alkali activated cementitious material (accounting for up to 50-70%), achieving high-value utilization of bulk industrial solid waste and solving environmental and safety problems caused by a storage of the copper molybdenum tailings. A multi-component solid waste synergistic excitation system is formed through a combination of copper molybdenum tailings, auxiliary calcium material, and silicon aluminum correction material. The auxiliary calcium material provides a strength skeleton, and the silicon aluminum correction material optimizes a gel structure, which together overcome the defect of insufficient activity of a single copper molybdenum tailings.

2. The copper molybdenum tailings based alkali activated cementitious material provided by the present disclosure has excellent mechanical properties through ratio optimization and system maintenance. A compressive strength of the copper molybdenum tailings based alkali activated cementitious material at 3 days can reach over 20 MPa and at 28 days can reach over 40 MPa, can meeting the strength requirements of general building materials. Preparation process of the present disclosure does not require high-temperature sintering and is only maintained at a temperature of 20-25 °C. Energy consumption and carbon emissions are much lower than traditional cement, which is in line with the development direction of green and low-carbon.

3. The present disclosure modifies nano-silica to improve the freeze-thaw resistance of the copper molybdenum tailings based alkali activated cementitious material.

4. The present disclosure uses a specific type of silicone acrylic lotion, under which the silicone acrylic lotion can better achieve synergistic effect with the modified nano-silica, and can improve strength of the copper molybdenum tailings based alkali activated cementitious material.

### DETAILED DESCRIPTION

The following will provide a clear and complete description of the technical solutions in the embodiments of the present disclosure. Obviously, the described embodiments are only a part of the embodiments of the present disclosure, and not all of them. Based on the embodiments of the present disclosure, all other embodiments obtained by ordinary skilled persons in the art without creative labor are within the scope of protection of the present disclosure.

Raw materials used in the following embodiments of the present disclosure are all commercially available goods:

polyetheramine JEFFAMINE® ED-600; an amine active hydrogen equivalent is 132 g/eq; brand: Huntsman.

Nano-silica: produced by Nanjing Tianxing New Materials Co., Ltd, a model is TSP-H10.

The copper molybdenum tailings, in terms of mass percentage, consist of CaO 42.5%, SiO₂ 25.6%, Al₂O₃ 5.3%, MgO 1.2%, and other components.

The granulated blast furnace slag powder, in terms of mass percentage, consist of SiO₂ 40.3%, CaO 38.5%, Al₂O₃ 4.5%, Fe₂O₃ 10.2%, MgO 4.7%, and other components.

The low calcium fly ash, in terms of mass percentage, consist of SiO₂ 58.2%, CaO 4.1%, Al₂O₃ 26.5%, Fe₂O₃ 6.8%, MgO 1.3%, and other components.

The carbide slag, in terms of mass percentage, consist of SiO₂ 3.2%, Al₂O₃ 1.4%, CaO 78.5%, Fe₂O₃ 0.9%, and other components.

The high kaolin, in terms of mass percentage, consist of SiO₂ 53.4%, Al₂O₃ 45.2%, Fe₂O₃ 0.8%.

The steel slag, in terms of mass percentage, consist of SiO₂ 13.5%, CaO 38.6%, Al₂O₃ 2.5%, Fe₂O₃ 26.7%, MgO 4.3%, and other components.

### Embodiment 1

The present embodiment provides a copper molybdenum tailings based alkali activated cementitious material, including: solid waste dry mixture, alkali activator solution, silicone acrylic lotion and modified nano-silica; where the solid waste dry mixture is composed of 60 parts of copper molybdenum tailings; 25 parts of auxiliary calcium material (granulated blast furnace slag powder); 15 parts of silicon aluminum correction material (low calcium fly ash). The silicone acrylic lotion accounts for 7% of the mass of the solid waste dry mixture; the modified nano-silica accounts for 1.0% of the mass of the solid waste dry mixture.

The alkali activator solution includes: sodium silicate solution, sodium hydroxide solution, and water. A modulus of sodium silicate in the alkaline activator solution (SiO₂/Na₂O) is 1.4. In the alkaline activator solution, Na₂O equivalent is calculated, and a mass of Na₂O is 6% of a mass of solid waste dry mixture; a ratio of a mass of water in the alkali activator solution to a mass of solid waste dry mixture is 0.50.

The silicone acrylic lotion includes silicone acrylic lotion A and silicone acrylic lotion B with a mass ratio of 1.6:1. Where the silicone acrylic lotion A has a viscosity of 500-1500 mPa·s, a glass transition temperature of 15-25 °C, a freeze-thaw stability is achieved through 5 cycles; the silicone acrylic lotion A is produced by Jiangsu Shengda New Material Technology Co., Ltd., a model is SD-528 Silicone Acrylic Lotion. The silicone acrylic lotion B is nano-silicone acrylic lotion with a viscosity of 500-1500 mPa·s, a glass transition temperature of 13-28 °C, and particle size of 50-80 nm, a freeze-thaw stability is achieved through 5 cycles; the silicone acrylic lotion B is produced by Jiangsu Shengda New Material Technology Co., Ltd., a model is SD-5281 nano-silicone acrylic lotion.

The preparation method of modified nano-silica including:
s1: adding 44.16 g polyetheramine JEFFAMINE® ED-600 to 1000 ml anhydrous xylene, dispersing evenly to obtain dispersion liquid;
s2: adding 10 ml triethylamine and γ-glycidoxypropyltrimethoxysilane to the dispersion liquid, a molar ratio of amine group in the polyetheramine JEFFAMINE® ED-600 to the γ-glycidoxypropyltrimethoxysilane is 2:1, react at 80 °C for 6 hours to obtain a mixed system;
s3: adding 9.1 g nano-silica to 500 ml anhydrous xylene, dispersing evenly, and obtain a nano-silica suspension;
s4: adding the nano-silica suspension into the mixed system, performing reflux reaction at 120 °C for 5 hours under nitrogen protection; after the reflux reaction is complete, filtering and drying to obtain modified nano-silica.

The preparation method of copper molybdenum tailings based alkali activated cementitious material, including:
s1: raw material pretreatment: drying copper molybdenum tailings at 105 °C to a constant weight, grinding the dried copper molybdenum tailings to a specific surface area of 450 m²/kg to obtain pretreated copper molybdenum tailings;
s2: material mixing: mixing the pretreated copper molybdenum tailings, auxiliary calcium material, and silicon aluminum correction material evenly to obtain a solid waste dry mixture;
s3: mixing molding: mixing the solid waste dry mixture, alkali activator solution, silicone acrylic lotion and modified nano-silica, using cement paste mixer for 5 min to obtain uniform slurry;
s5: maintaining: maintaining at room temperature of 20 °C after forming the uniform slurry to obtain copper molybdenum tailings based alkali activated cementitious material.

### Embodiment 2

The present embodiment provides a copper molybdenum tailings based alkali activated cementitious material, including: solid waste dry mixture, alkali activator solution, silicone acrylic lotion and modified nano-silica; where the solid waste dry mixture is composed of 65 parts of copper molybdenum tailings; 25 parts of auxiliary calcium material (20 parts of granulated blast furnace slag powder, 5 parts of carbide slag); 10 parts of silicon aluminum correction material (low calcium fly ash). The silicone acrylic lotion accounts for 6% of the mass of the solid waste dry mixture; the modified nano-silica accounts for 1.2% of the mass of the solid waste dry mixture.

The alkali activator solution includes: sodium silicate solution, sodium hydroxide solution, and water. A modulus of sodium silicate in the alkaline activator solution (SiO₂/Na₂O) is 1.2. In the alkaline activator solution, Na₂O equivalent is calculated, and a mass of Na₂O is 4% of a mass of solid waste dry mixture; a ratio of a mass of water in the alkali activator solution to a mass of solid waste dry mixture is 0.40.

The silicone acrylic lotion includes silicone acrylic lotion A and silicone acrylic lotion B with a mass ratio of 1.5:1. Where the silicone acrylic lotion A has a viscosity of 500-1500 mPa·s, a glass transition temperature of 15-25 °C, a freeze-thaw stability is achieved through 5 cycles; the silicone acrylic lotion A is produced by Jiangsu Shengda New Material Technology Co., Ltd., a model is SD-528 Silicone Acrylic Lotion. The silicone acrylic lotion B is nano-silicone acrylic lotion with a viscosity of 500-1500 mPa·s, a glass transition temperature of 13-28 °C, and particle size of 50-80 nm, a freeze-thaw stability is achieved through 5 cycles; the silicone acrylic lotion B is produced by Jiangsu Shengda New Material Technology Co., Ltd., a model is SD-5281 nano-silicone acrylic lotion.

The preparation method of modified nano-silica including:
s1: adding 44.16 g polyetheramine JEFFAMINE® ED-600 to 1000 ml anhydrous xylene, dispersing evenly to obtain dispersion liquid;
s2: adding 10 ml triethylamine and γ-glycidoxypropyltrimethoxysilane to the dispersion liquid, a molar ratio of amine group in the polyetheramine JEFFAMINE® ED-600 to the γ-glycidoxypropyltrimethoxysilane is 2:1, react at 80 °C for 6 hours to obtain a mixed system;
s3: adding 9.1 g nano-silica to 500 ml anhydrous xylene, dispersing evenly, and obtain a nano-silica suspension;
s4: adding the nano-silica suspension into the mixed system, performing reflux reaction at 120 °C for 5 hours under nitrogen protection; after the reflux reaction is complete, filtering and drying to obtain modified nano-silica.

The preparation method of copper molybdenum tailings based alkali activated cementitious material, including:
s1: raw material pretreatment: drying copper molybdenum tailings at 105 °C to a constant weight, grinding the dried copper molybdenum tailings to a specific surface area of 450 m²/kg to obtain pretreated copper molybdenum tailings;
s2: material mixing: mixing the pretreated copper molybdenum tailings, auxiliary calcium material, and silicon aluminum correction material evenly to obtain a solid waste dry mixture;
s3: mixing molding: mixing the solid waste dry mixture, alkali activator solution, silicone acrylic lotion and modified nano-silica, using cement paste mixer for 5 min to obtain uniform slurry;
s5: maintaining: maintaining at room temperature of 20 °C after forming the uniform slurry to obtain copper molybdenum tailings based alkali activated cementitious material.

### Embodiment 3

The present embodiment provides a copper molybdenum tailings based alkali activated cementitious material, including: solid waste dry mixture, alkali activator solution, silicone acrylic lotion and modified nano-silica; where the solid waste dry mixture is composed of 70 parts of copper molybdenum tailings; 20 parts of auxiliary calcium material (15 parts of granulated blast furnace slag powder, 5 parts of steel slag); 10 parts of silicon aluminum correction material (5 parts of low calcium fly ash, 5 parts of high kaolin). The silicone acrylic lotion accounts for 8% of the mass of the solid waste dry mixture; the modified nano-silica accounts for 0.8% of the mass of the solid waste dry mixture.

The alkali activator solution includes: sodium silicate solution, sodium hydroxide solution, and water. A modulus of sodium silicate in the alkaline activator solution (SiO₂/Na₂O) is 1.6. In the alkaline activator solution, Na₂O equivalent is calculated, and a mass of Na₂O is 6% of a mass of solid waste dry mixture; a ratio of a mass of water in the alkali activator solution to a mass of solid waste dry mixture is 0.45.

The silicone acrylic lotion includes silicone acrylic lotion A and silicone acrylic lotion B with a mass ratio of 1.8:1. Where the silicone acrylic lotion A has a viscosity of 500-1500 mPa·s, a glass transition temperature of 15-25 °C, a freeze-thaw stability is achieved through 5 cycles; the silicone acrylic lotion A is produced by Jiangsu Shengda New Material Technology Co., Ltd., a model is SD-528 Silicone Acrylic Lotion. The silicone acrylic lotion B is nano-silicone acrylic lotion with a viscosity of 500-1500 mPa·s, a glass transition temperature of 13-28 °C, and particle size of 50-80 nm, a freeze-thaw stability is achieved through 5 cycles; the silicone acrylic lotion B is produced by Jiangsu Shengda New Material Technology Co., Ltd., a model is SD-5281 nano-silicone acrylic lotion.

The preparation method of modified nano-silica including:
s1: adding 44.16 g polyetheramine JEFFAMINE® ED-600 to 1000 ml anhydrous xylene, dispersing evenly to obtain dispersion liquid;
s2: adding 10 ml triethylamine and γ-glycidoxypropyltrimethoxysilane to the dispersion liquid, a molar ratio of amine group in the polyetheramine JEFFAMINE® ED-600 to the γ-glycidoxypropyltrimethoxysilane is 2:1, react at 80 °C for 6 hours to obtain a mixed system;
s3: adding 9.1 g nano-silica to 500 ml anhydrous xylene, dispersing evenly, and obtain a nano-silica suspension;
s4: adding the nano-silica suspension into the mixed system, performing reflux reaction at 120 °C for 5 hours under nitrogen protection; after the reflux reaction is complete, filtering and drying to obtain modified nano-silica.

The preparation method of copper molybdenum tailings based alkali activated cementitious material, including:
s1: raw material pretreatment: drying copper molybdenum tailings at 105 °C to a constant weight, grinding the dried copper molybdenum tailings to a specific surface area of 450 m²/kg to obtain pretreated copper molybdenum tailings;
s2: material mixing: mixing the pretreated copper molybdenum tailings, auxiliary calcium material, and silicon aluminum correction material evenly to obtain a solid waste dry mixture;
s3: mixing molding: mixing the solid waste dry mixture, alkali activator solution, silicone acrylic lotion and modified nano-silica, using cement paste mixer for 5 min to obtain uniform slurry;
s5: maintaining: maintaining at room temperature of 20 °C after forming the uniform slurry to obtain copper molybdenum tailings based alkali activated cementitious material.

### Comparative Embodiment 1

The present comparative embodiment is a product of Embodiment 2 in CN111454011B, a method for preparing alkali activated cementitious materials using engineering slag and alkali activated cementitious materials.

### Comparative Embodiment 2

Difference between the present embodiment and Embodiment 1 is: the silicone acrylic lotion used in the present embodiment is silicone acrylic lotion A, where the silicone acrylic lotion A has a viscosity of 500-1500 mPa·s, a glass transition temperature of 15-25 °C, a freeze-thaw stability is achieved through 5 cycles; the silicone acrylic lotion A is produced by Jiangsu Shengda New Material Technology Co., Ltd., a model is SD-528 Silicone Acrylic Lotion.

### Comparative Embodiment 3

Difference between the present embodiment and Embodiment 1 is: the silicone acrylic lotion used in the present embodiment is silicone acrylic lotion B, where the silicone acrylic lotion B is nano-silicone acrylic lotion with a viscosity of 500-1500 mPa·s, a glass transition temperature of 13-28 °C, and particle size of 50-80 nm, a freeze-thaw stability is achieved through 5 cycles; the silicone acrylic lotion B is produced by Jiangsu Shengda New Material Technology Co., Ltd., a model is SD-5281 nano-silicone acrylic lotion.

### Comparative Embodiment 4

Difference between the present embodiment and Embodiment 1 is: the silicone acrylic lotion used in the present embodiment includes silicone acrylic lotion A and silicone acrylic lotion B with a mass ratio of 1:1.2. Where the silicone acrylic lotion A has a viscosity of 500-1500 mPa·s, a glass transition temperature of 15-25 °C, a freeze-thaw stability is achieved through 5 cycles; the silicone acrylic lotion A is produced by Jiangsu Shengda New Material Technology Co., Ltd., a model is SD-528 Silicone Acrylic Lotion. The silicone acrylic lotion B is nano-silicone acrylic lotion with a viscosity of 500-1500 mPa·s, a glass transition temperature of 13-28 °C, and particle size of 50-80 nm, a freeze-thaw stability is achieved through 5 cycles; the silicone acrylic lotion B is produced by Jiangsu Shengda New Material Technology Co., Ltd., a model is SD-5281 nano-silicone acrylic lotion.

### Comparative Embodiment 5

Difference between the present embodiment and Embodiment 1 is: a model of the silicone acrylic lotion used in the present embodiment is Badefu RS-9966A, produced by Cansen Chemical New Materials (Shenzhen) Co., Ltd.

### Comparative Embodiment 6

Difference between the present embodiment and Embodiment 1 is: replacing the modified nano-silica with nano-silica. Where the nano-silica is produced by Nanjing Tianxing New Materials Co., Ltd., model TSP-H10.

### Comparative Embodiment 7

Difference between the present embodiment and Embodiment 1 is: replacing the polyetheramine JEFFAMINE® ED-600 with polyetheramine JEFFAMINE® M-2070. Where a model is Huntsman, an amine active hydrogen equivalent in polyetheramine (g/eq) is 1040.

### Performance Test

1. Flexural strength and compressive strength of the cementitious material in Embodiment 1-Embodiment 3 and Comparative Embodiment 1-Comparative Embodiment 7 is tested according to GB/T17671 2021 “Method for Testing the Strength of Cement Mortar”. Two sides of a specimen during molding is selected as compression surfaces, with an area of 40 mm×40 mm. An average of the results of the six specimens are taken.

2. A test for the number of freeze-thaw cycles is conducted according to the freeze-thaw test specified in GB/T50082 2024. A size of the specimen is 100 mm×100 mm×400 mm. At an end of melting operations, a center temperature of the specimen is controlled within 5 °C; at an end of freezing operations, a center temperature of the specimen is controlled within-18 °C. A conversion time between melting and freezing is 8 minutes.

The results are shown in Table 1.

TABLE 1
Performance test results of copper molybdenum tailings
based alkali activated cementitious material

| | 3-day | 28-day | | | Number of |
|---|---|---|---|---|---|
| | compressive | compressive | 3-day flexural | 3-day flexural | freeze-thaw |
| Serial mumber | strength/MPa | strength/MPa | strength/MPa | strength/MPa | cycles |
| Embodiment 1 | 28.01 | 47.87 | 5.6 | 9.0 | 333 |
| Embodiment 2 | 27.34 | 46.32 | 5.3 | 8.5 | 314 |
| Embodiment 3 | 26.69 | 45.28 | 5.1 | 8.8 | 325 |
| Comparative | 25.45 | 44.36 | 4.4 | 7.5 | 252 |
| embodiment 1 | | | | | |
| Comparative | 23.73 | 42.13 | 4.5 | 7.2 | 263 |
| embodiment 2 | | | | | |
| Comparative | 23.86 | 40.73 | 4.7 | 7.6 | 284 |
| embodiment 3 | | | | | |
| Comparative | 25.07 | 43.86 | 4.9 | 8.0 | 301 |
| embodiment 4 | | | | | |
| Comparative | 22.41 | 38.30 | 4.3 | 7.1 | 256 |
| embodiment 5 | | | | | |
| Comparative | 23.20 | 39.69 | 4.6 | 7.7 | 261 |
| embodiment 6 | | | | | |
| Comparative | 25.24 | 43.08 | 5.0 | 8.1 | 289 |
| embodiment 7 | | | | | |

According to Table 1, the copper molybdenum tailings based alkali activated cementitious material prepared in Embodiments 1-3 have high strength, good freeze-thaw resistance, and superior comprehensive performance compared to existing technology products.

According to the Comparative embodiment 2-5, strength of the copper molybdenum tailings based alkali activated cementitious material decreases with the change of the model and ratio of silicone acrylic lotion.

According to the Comparative embodiments 6-7, modifying nano-silica with specific types of polyetheramines can significantly improve the freeze-thaw effect. It is analyzed that molecular weight and amine hydrogen equivalent in polyetheramine used in Embodiment 1-Embodiment 3 has a more reasonable number of reactive amine groups and can better react with silane coupling agents, grafting density is better, forming a dense polymer brush that can achieve higher anti-freezing and toughening functions.

The above is the preferred embodiment of the present disclosure, and it should be pointed out that for ordinary technical personnel in this field, several improvements and embellishments can be made without departing from the principles of the present disclosure. The improvements and embellishments should also be considered within the scope of protection of the present disclosure.

What is claimed is:

1. A copper molybdenum tailings based alkali activated cementitious material, comprising: solid waste dry mixture, alkali activator solution, silicone acrylic lotion and modified nano-silica; wherein the solid waste dry mixture is composed of 50-70 parts of copper molybdenum tailings; 10-30 parts of auxiliary calcium material; 10-20 parts of silicon aluminum correction material;
wherein the silicone acrylic lotion comprises silicone acrylic lotion A and silicone acrylic lotion B with a mass ratio of 1.5-1.8:1; wherein the silicone acrylic lotion A has a viscosity of 500-1500 mPa·s, a glass transition temperature of 15-25 °C; the silicone acrylic lotion B is nano-silicone acrylic lotion with a viscosity of 500-1500 mPa·s, a glass transition temperature of 13-28 °C, and particle size of 50-80 nm;
wherein a preparation method of modified nano-silica comprises:
s1: adding polyetheramine to anhydrous xylene, dispersing evenly to obtain dispersion liquid;
s2: adding triethylamine and γ-glycidoxypropyltrimethoxysilane to the dispersion liquid, heating and reacting to obtain a mixed system;
s3: adding nano-silica to anhydrous xylene, dispersing evenly, and obtain a nano-silica suspension;
s4: adding the nano-silica suspension into the mixed system, performing reflux reaction under nitrogen protection; after the reflux reaction is complete, filtering and drying to obtain modified nano-silica;
wherein the modified nano-silica accounts for 0.8-1.2% of the mass of the solid waste dry mixture;
wherein the silicone acrylic lotion accounts for 6-8% of the mass of the solid waste dry mixture.

2. The copper molybdenum tailings based alkali activated cementitious material according to claim 1, wherein the alkali activator solution comprises sodium silicate solution, sodium hydroxide solution, and water, a modulus of sodium silicate in the alkaline activator solution is 1.2-2.0; a ratio of a mass of water in the alkali activator solution to a mass of solid waste dry mixture is 0.40-0.60.

3. The copper molybdenum tailings based alkali activated cementitious material according to claim 2, wherein the auxiliary calcium material is one of granulated blast furnace slag powder, steel slag, and carbide slag or more of granulated blast furnace slag powder, steel slag, and carbide slag.

4. The copper molybdenum tailings based alkali activated cementitious material according to claim 1, wherein the silicon aluminum correction material is one of low calcium fly ash and high kaolin or more of low calcium fly ash and high kaolin.

5. The copper molybdenum tailings based alkali activated cementitious material according to claim 1, wherein an amine active hydrogen equivalent in polyetheramine is 130-135 g/eq.

6. The copper molybdenum tailings based alkali activated cementitious material according to claim 5, wherein a molar ratio of amine group in the polyetheramine to the Y-glycidoxypropyltrimethoxysilane is (2-2.2):1.

7. A preparation method of copper molybdenum tailings based alkali activated cementitious material, which is applied in obtaining the copper molybdenum tailings based alkali activated cementitious material according to claim 1, wherein the preparation method of copper molybdenum tailings based alkali activated cementitious material comprising:
s1: raw material pretreatment: drying and grinding copper molybdenum tailings to obtain pretreated copper molybdenum tailings;
s2: material mixing: mixing the pretreated copper molybdenum tailings, auxiliary calcium material, and silicon aluminum correction material evenly to obtain a solid waste dry mixture;
s3: mixing molding: mixing the solid waste dry mixture, alkali activator solution, silicone acrylic lotion and modified nano-silica, using cement paste mixer for 4-6 min to obtain uniform slurry;
s5: maintaining: maintaining at room temperature of 20-25 °C after forming the uniform slurry to obtain copper molybdenum tailings based alkali activated cementitious material.

8. The preparation method of copper molybdenum tailings based alkali activated cementitious material according to claim 7, wherein the alkali activator solution comprises sodium silicate solution, sodium hydroxide solution, and water, a modulus of sodium silicate in the alkaline activator solution is 1.2-2.0; a ratio of a mass of water in the alkali activator solution to a mass of solid waste dry mixture is 0.40-0.60.

9. The preparation method of copper molybdenum tailings based alkali activated cementitious material according to claim 8, wherein the auxiliary calcium material is one of granulated blast furnace slag powder, steel slag, and carbide slag or more of granulated blast furnace slag powder, steel slag, and carbide slag.

10. The preparation method of copper molybdenum tailings based alkali activated cementitious material according to claim 7, wherein the silicon aluminum correction material is one of low calcium fly ash and high kaolin or more of low calcium fly ash and high kaolin.

11. The preparation method of copper molybdenum tailings based alkali activated cementitious material according to claim 7, wherein an amine active hydrogen equivalent in polyetheramine is 130-135 g/eq.

12. The preparation method of copper molybdenum tailings based alkali activated cementitious material according to claim 11, wherein a molar ratio of amine group in the polyetheramine to the γ-glycidoxypropyltrimethoxysilane is (2-2.2):1.
